(19) United States
(12) Patent Application Publication
(10) Pub. No.: US 2024/0411821 A1
(43) Pub. Date: Dec. 12, 2024

(54) CITATION BRIDGE PLATFORM AND METHOD FOR LOCALIZATION OF PINPOINT ELEMENTS

(71) Applicant: PRIMACY INTELLECTUAL PROPERTY PTE. LTD, Singapore (SG)

(72) Inventors: Agostinho Guilherme MANHAO, Singapore (SG); Nicholas DARVEY, Singapore (SG); Tri Minh NGUYEN, Singapore (SG)

(73) Assignee: PRIMACY INTELLECTUAL PROPERTY PTE. LTD, Singapore (SG)

(21) Appl. No.: 18/700,138

(22) PCT Filed: Oct. 11, 2021
(86) PCT No.: PCT/SG2021/050610

§ 371 Date: Apr. 10, 2024

(51) Int. Cl. G06F 16/93; G06F 16/25; G06F 16/955

(52) U.S. Cl. CPC G06F 16/93; G06F 16/258; G06F 16/955

(57) ABSTRACT

A general embodiment of the invention is a citation bridge platform 31 or a computer-implemented method for receiving and localizing bridge requests. Each bridge request includes or links to a first local document 40A with a first set of pinpoint elements formatted according to a first local convention LC1. Each bridge request also identifies a second local convention LC2 to which the first set of pinpoint elements should be localized to create a second set of pinpoint element for a second local document 40B. The platform 31 or method first globalizes the set of pinpoint elements of the first local document 40A by mapping them to a bridge set 40C of bridge elements formatted according to a bridge convention BC. Second, the platform 31 or method creates the second set of pinpoint elements for the second local document 40B by mapping the bridge set 40C of bridge elements into the second set of pinpoint elements created for the second local document 40B according to a second local convention LC2.

### TECHNICAL CONTRIBUTION

The present disclosure relates to localization of citations contained within local documents. More particularly, the present disclosure relates to a citation bridge platform and method for localization of pinpoint elements from a first local convention of a first local document to a second local convention of a second local document.

### BACKGROUND

The citation format of provisions cited within legal documents generally follows strict local syntax rules of a local convention. Larger jurisdictions often publish these local syntax rules for the legal community. Many of these local syntax rules existed long before the advent of computers, word processing, or the world wide web.

Local documents are typically formatted according to a set of local syntax rules for a local convention can be found in the Australian Guide to Legal Citation published last in a fourth edition in 2018 by the Melbourne University Law Review Association (hereafter, “the AGLC4”). As listed in the chart 1A-00 of FIG. 1A, the laws of the specific Australian jurisdictions are identified in the AGLC4 by specific abbreviations. Similarly, as depicted in chart 1B-00 of FIG. 1B, delegated legislation types are identified in the AGLC4 by specific abbreviations. Also, as depicted in chart 1C-00 of FIG. 1C, provisions types are identified in the AGLC4 by specific abbreviations.

With modern document file formats, such as the Extensible Markup Language (XML), local documents for a jurisdiction can now be published as electronic documents with embedded meta data. Extensible Markup Language (XML) is a markup language that defines a set of rules for encoding documents in a machine readable format that can be rendered by a computing device to a human readable format. The meta data within XML files can enable the automated generation of a table of contents for local documents.

As an example of the human readable rendering of a local document stored in XML format, FIG. 2 illustrates a human readable rendering of the local document with a table of contents 2A-00 linked to a text area 2B-00. By clicking the reference section 18 in the table of contents area 2A-00, the user can direct the text area 2B-00 to display the text of the reference section 18. In addition to reference sections, generic pinpoints can identify in a local document a specific page, a specific paragraph, a specific footnote, or some other specific subsection of the local document. The mapping 2AB between the table of contents area 2A-00 and the text area 2B-00 is accomplished by use of a generic pinpoint that identifies (with machine readable meta data) the reference section 18 within the local document.

As used in the existing art, presentation of local documents using generic pinpoints are limited to presentation of the local document itself. For instance, as depicted in FIG. 2, generic pinpoints can be used to create tables of contents for the local document. The existing art, however, does not address the need to cross-reference generic pinpoints between multiple local documents. For instance, compliance programs for even small companies must assimilate the legislative provisions published by multiple separate governmental departments that collectively govern the company's jurisdiction. Multi-national companies must often consider the impact of legislative provisions between the multiple countries in which they do business. While cross-referencing may be done “by hand”, this is a painstaking process and must be redone whenever the associated local documents are updated.

### SUMMARY

A general embodiment of the invention is a citation bridge platform or a computer-implemented method for receiving and localizing bridge requests. Each bridge request includes or links to a first local document with a first set of pinpoint elements formatted according to a first local convention. Each bridge request also identifies a second local convention to which the first set of pinpoint elements should be localized to create a second set of pinpoint element for a second local document. The platform or method first globalizes the set of pinpoint elements of the first local document by mapping them to a bridge set of bridge elements formatted according to a bridge convention. Second, the platform or method creates the second set of pinpoint elements for the second local document by mapping the bridge set of bridge elements into the second set of pinpoint elements created for the second local document. The second set of pinpoint elements are formatted according to the second local convention of the second local document.

A platform embodiment of the invention is a citation bridge platform for receiving and localizing a plurality of bridge requests, the platform including: (a) a bridge library; (b) a request queue; (c) a globalization module; (d) a localization module; and (e) an output module configured to export or provide access to the second local document.

The bridge library of the platform embodiment is configured to store or link directly or indirectly to: (i) a plurality of local conventions for local documents; and (ii) a bridge convention. Each local convention includes a set of local syntax rules dictating formatting of pinpoint elements contained within the local documents associated with the local convention. Each pinpoint element includes a local element ID, a local element type, and a local reference. The bridge convention includes a set of bridge syntax rules dictating formatting of bridge elements. Each bridge element includes at least one bridge element ID, at least one bridge element type, and at least one bridge reference.

The request queue of the platform embodiment is configured to receive each of the plurality of bridge requests. Each bridge request includes or links directly or indirectly to: (i) a first local document of the local documents; and (ii) a selection of a second local convention of the local conventions for generation of a second local document with a second set of pinpoint elements formatted according to a second set of local syntax rules according the second local convention. The first local document includes a first set of pinpoint elements. The first set of pinpoint elements are formatted according to a first set of local syntax rules according to a first local convention of the local conventions.

The globalization module of the platform embodiment is in data communication with: (1) the bridge library; and (2) the request queue. For the first local document of each bridge request, the globalization module is configured to: (1) identify the first local convention of the first local document of the bridge request; (2) access the set of local syntax rules for the first local convention associated with first local document of the bridge request; and (3) create a bridge set of bridge elements associated with the first local document by mapping directly or indirectly each bridge element of the bridge set to one pinpoint element of the first set of pinpoint elements of the first local document. The at least one bridge element ID of the bridge element of the bridge set is mapped directly or indirectly to the local element ID of the one pinpoint element of the first set of pinpoint elements of the first local document. The at least one bridge element type of the bridge element of the bridge set is mapped directly or indirectly to the local element type of the one pinpoint element of the first set of pinpoint elements of the first local document. The at least one bridge reference of the bridge element of the bridge set is mapped directly or indirectly to the local reference of the one pinpoint element of the first set of pinpoint elements of the first local document.

The localization module of the platform embodiment is, for each bridge request, linked directly or indirectly to: (1) the request queue; (2) the bridge library; and (3) the bridge set of bridge elements associated with the first local document of the bridge request. For the second local document of each bridge request, the localization module is configured to: (1) access from the request queue the selection of the second location convention for the bridge request; (2) access the second set of local syntax rules for the second local convention identified in the bridge request; and (3) create the second set of pinpoint elements for the second local document by mapping directly or indirectly each bridge element of the bridge set to one pinpoint element of the second set of pinpoint elements of the second local document. The at least one bridge element ID of the bridge element of the bridge set is mapped directly or indirectly to the local element ID of the one pinpoint element of the second set of pinpoint elements of the second local document. The at least one bridge element type of the bridge element of the bridge set is mapped directly or indirectly to the local element type of the one pinpoint element of the second set of pinpoint elements of the second local document. The at least one bridge reference of the bridge element of the bridge set is mapped directly or indirectly to the local reference of the one pinpoint element of the second set of pinpoint elements of the second local document.

A method embodiment of the invention is a computer-implemented method for receiving and localizing a plurality of bridge requests, the method comprising: (a) maintaining a bridge library; (b) maintaining a request queue; (c) for each bridge request, receiving the bridge request at the request queue; and (d) exporting or providing access to a second local document.

In the method embodiment, the bridge library is configured to store or link directly or indirectly to: (i) a plurality of local conventions for local documents; and (ii) a bridge convention. Each local convention includes a set of local syntax rules dictating formatting of pinpoint elements contained within the local documents associated with the local convention. Each pinpoint element includes a local element ID, a local element type, and a local reference. The bridge convention includes a set of bridge syntax rules dictating formatting of bridge element. Each bridge element includes at least one bridge element ID, at least one bridge element type, and at least one bridge reference;

In the method embodiment, the request queue is configured to receive each of the plurality of bridge requests. Each bridge request includes or links directly or indirectly to: (i) a first local document of the local documents; and (ii) a selection of a second local convention of the local conventions for generation of a second local document with a second set of pinpoint elements formatted according to a second set of local syntax rules according the second local convention. The first local document includes a first set of pinpoint elements. The first set of pinpoint elements are formatted according to a first set of local syntax rules according to a first local convention of the local conventions.

In the method embodiment, for the first local document of each bridge request, the method includes: (i) identifying the first local convention of the first local document of the bridge request; (ii) accessing the set of local syntax rules for the first local convention associated with first local document of the bridge request; and (iii) creating a bridge set of bridge elements associated with the first local document by mapping directly or indirectly each bridge element of the bridge set to one pinpoint element of the first set of pinpoint elements of the first local document.

In the method embodiment, for the second local document of each bridge request, the method includes: (i) accessing from the request queue the selection of the second location convention for the bridge request; (ii) accessing the second set of local syntax rules for the second local convention identified in the bridge request; and (iii) creating the second set of pinpoint elements for the second local document by mapping directly or indirectly each bridge element of the bridge set to one pinpoint element of the second set of pinpoint elements of the second local document.

In the method embodiment, at least one bridge element ID of the bridge element of the bridge set is mapped directly or indirectly to the local element ID of the one pinpoint element of the first set of pinpoint elements of the first local document. The at least one bridge element type of the bridge element of the bridge set is mapped directly or indirectly to the local element type of the one pinpoint element of the first set of pinpoint elements of the first local document. The at least one bridge reference of the bridge element of the bridge set is mapped directly or indirectly to the local reference of the one pinpoint element of the first set of pinpoint elements of the first local document;

In the method embodiment, at least one bridge element ID of the bridge element of the bridge set is mapped directly or indirectly to the local element ID of the one pinpoint element of the second set of pinpoint elements of the second local document. The at least one bridge element type of the bridge element of the bridge set is mapped directly or indirectly to the local element type of the one pinpoint element of the second set of pinpoint elements of the second local document. The at least one bridge reference of the bridge element of the bridge set is mapped directly or indirectly to the local reference of the one pinpoint element of the second set of pinpoint elements of the second local document.

In contrast to the background art, the invention enables bridging of the meta data contained within the pinpoint elements between separate local documents by leveraging use of the consistent use of local syntax rules within local documents. The invention enables localization of the citation format for foreign laws to an individual's or corporation's local jurisdiction. Within a single jurisdiction, the invention enables cross-references of the legislative provisions of multiple separate governmental departments. Within a country, like Australia, that has multiple sets of unique laws enacted by different states and territories, the invention enables cross-referencing (or normalizing the citation format) between the local documents of each state or territory.

Such bridging of citations opens up the possibility to cross-reference the provisions impacting a business into a single document or visual representation. The bridging of citations also opens up the possibility to navigate between different types of local documents, such as between legislative provisions and case law decisions. The invention can also be used to port pinpoint elements of first local documents to an API or other data entry portal of a software application employed to organize and view the citations (such as on a computer screen or website portal window).

### BRIEF DESCRIPTION OF THE DRAWINGS

Embodiments of the present disclosure are described herein with reference to the drawings in which:

FIGS. 1A to 1C are tables detailing abbreviations used for designations in a set of local syntax rules of a local convention in the prior art.

FIG. 2 is a diagram illustrating a human readable rendering of a local document that employs use of the generic pinpoint in both a table of contents area and a text area in the prior art.

FIG. 3 is a block diagram illustrating a citation bridge system including a citation bridge platform, in an embodiment of the invention.

FIG. 4 is a block diagram illustrating mapping, for an embodiment of the invention, between: (a) a first set of pinpoint elements in a first local document; (b) a bridge set of bridging elements; and (c) a second set of pinpoint elements in a second local document.

FIG. 5 is a chart illustrating, in an embodiment of the invention, the relationship between: (a) a human readable rendering of a pinpoint element for a first local document; (b) a set of machine readable metadata for the pinpoint element of the first local document; and (c) a pinpoint element localized by the citation bridge platform for a second local document.

FIG. 6 is a flowchart detailing method steps for localizing a pinpoint element of a first local documents into a pinpoint element of a second local document in an embodiment of the invention.

### DETAILED DESCRIPTION

In the following detailed description, reference is made to the accompanying drawings, which form a part hereof. The illustrative embodiments described in the detailed description, drawings and claims are not meant to be limiting. Other embodiments can be utilized, and other changes can be made, without departing from the spirit or scope of the subject matter presented herein. Unless specified otherwise, the terms “comprising.” “comprise,” “including” and “include” used herein, and grammatical variants thereof, are intended to represent “open” or “inclusive” language such that they include recited elements but also permit inclusion of additional, un-recited elements. As used herein, a platform may reside within a single stand-alone computer, a server, multiple dedicated servers, a cloud-based service, and/or a virtual server running on a larger network of servers. As used herein, a library may store data to and access data from a single stand-alone computer, a data server, multiple dedicated data servers, a cloud-based service, and/or a virtual server running on a larger network of servers.

While examples from XML are provided in this disclosure, the invention can also be implemented in any type of structured hierarchical local document. For instance, the invention can also be implemented in HTML and JSON.

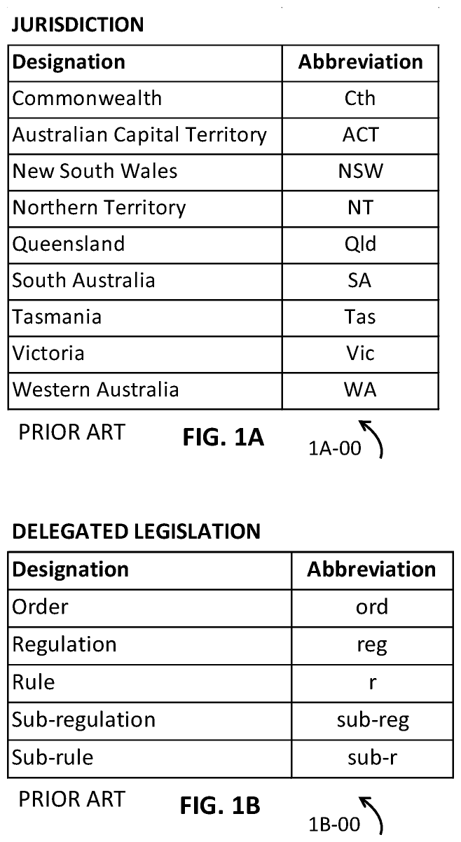

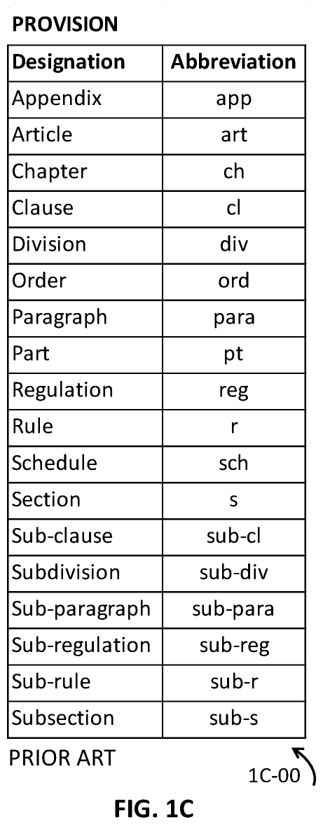

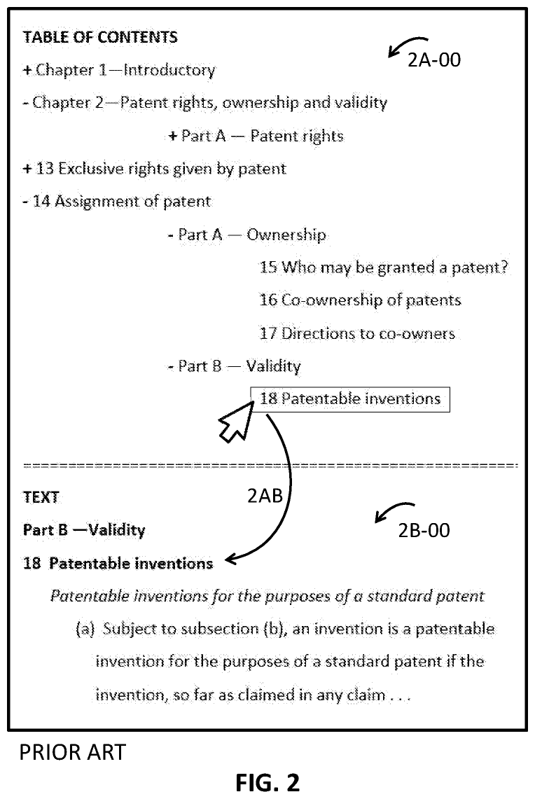

FIGS. 1A-1C and FIG. 2 are detailed in the Background section of this description and relate to use of generic pinpoints in the prior art.

The invention expands the scope of metadata included within local documents (e.g., documents published by a jurisdiction in XML, HTML, or JSON file format). The term “pinpoint element” is used in this specification to denote the use of additional meta data that goes beyond the generic pinpoint used in the prior art. As used in this specification, each pinpoint element can include such information as a local element ID (e.g., a unique machine readable alphanumeric string, which is not visible in the human readable rendering), a local element type (e.g., one of a selection of machine readable section type identifiers such as “chapter id” and “part id”, which is not visible in the human readable rendering), a local reference (e.g., “18” to identify the provision section number), a local level (e.g., one of a selection of machine readable level types such as “h2”, “h3”, and “h4”, which is not visible in the human readable rendering, indicating the position of the section within a hierarchy of the sections of the provision), a local preamble (e.g., “Chapter” or “Part”), and a local heading (e.g., “Patentable inventions”).

Pinpoint elements are similar to an “element identifier”, as used in XML and HTML documents, in that each pinpoint element refers to a specific element in the local document. However, where an element identifier is intended for machines and might be a UUID (e.g., “ca74b5e4-3ab2-4fae-bccf-61c6d49aec81”), a pinpoint element is structured to also include data for rendering human readable content. A local document can include a set of pinpoint elements to identify each reference section in the local document.

To provide a predictable user experience when reading local documents, the XML rendering of pinpoint elements is, according to the invention, generally aligned with the set of local syntax rules for the local convention of the jurisdiction publishing the local document. When used in a consistent manner, these abbreviations can be machine readable meta data (e.g., employed as a variable or string by a computing device when reading an XML local document).

Beyond publication in a human readable rendering, such as pdf or tiff files, local syntax rules for a local convention can also be consolidated into an XML namespace cross-referenced by a header within an XML local document. The header can establish a link from the XML local document to either a web address or a file on the computing device of the user. Jurisdictions, such as Australia, can host the latest updated version of the local syntax rules, for instance, on a local server connectable to a computing device (such as a desktop computer, laptop computer, tablet, or smart phone) via a network.

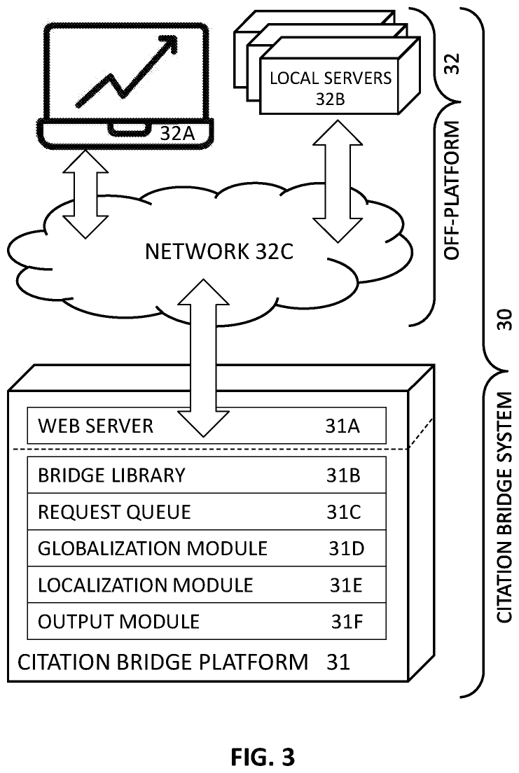

FIG. 3 is a block diagram illustrating a citation bridge system 30 including a citation bridge platform 31, in an embodiment of the invention. The citation bridge platform 31 includes a web server 31A, a bridge library 31B, a request queue 31C, a globalization module 31D, a localization module 31E, and an output module 31F. Off-platform 32 items illustrated in FIG. 3 include a network 32C, a plurality of computing devices 32A, and a plurality of local servers 32B. The citation bridge platform 31 is in data communication via the network 32C with the computing devices 32A and the local servers 32B.

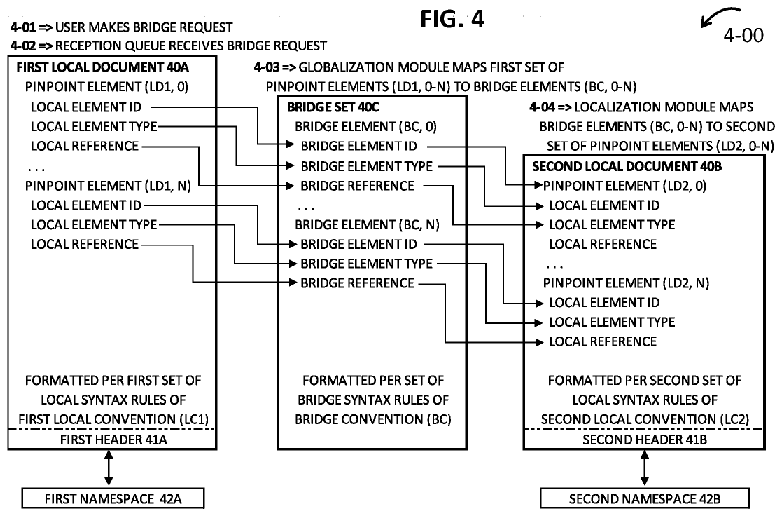

FIG. 4 is a block diagram illustrating mapping, for an embodiment of the invention, between: (a) a first set of pinpoint elements in a first local document 40A; (b) a bridge set 40C of bridging elements; and (c) a second set of pinpoint elements in a second local document 40B. FIG. 4 illustrates four steps 4-01 to 4-04 in the mapping process.
4-01 user makes bridge request
4-02 reception queue receives bridge request
4-03 globalization module 31D maps first set of pinpoint elements (LD1, 0-N) to bridge elements (BC, 0-N)
4-04 localization module 31E maps bridge elements (BC, 0-N) to second set of pinpoint elements (LD2, 0-N)

The first local document 40A has a first set of pinpoint elements (LD1, 0-N). The bridge set 40C of bridge elements (BC, 0-N) are created from the first set of pinpoint elements (LD1, 0-N). In turn the second set of bridge elements (LD2, 0-N) are created from the bridge set 40C of bridge elements (BC, 0-N). The local element IDs of the first local document 40A are mapped from to the bridge element IDs to the local element IDs of the second local document 40B. The local element types are mapped from the first local document 40A to the bridge element types to the local element types of the second local document 40B. The local references are mapped from the first local document 40A to the bridge references to the local references of the second local document 40B.

As noted in FIG. 4, the first set of pinpoint elements (LD1, 0-N) of the first local document 40A are formatted per the first set of local syntax rule of a first local convention LC1. The bridge set 40C of bridge elements (BC, 0-N) are formatted per the bridge syntax rules of the bridge convention BC. The second set of pinpoint elements (LD2, 0-N) of the second local document 40B are formatted per the second set of local syntax rules of the second local convention LC2. The first local document 40A can link to a first namespace 42A via a link in a first header 41A of the first local document 40A. The second local document 40B can be configured to include a second header 41B that links to a second namespace 42B. As illustrated in FIG. 3, the namespaces can be XML namespaces hosted on local servers 32B in data communication with the web server 31A of the citation bridge platform 31 via the network 32C.

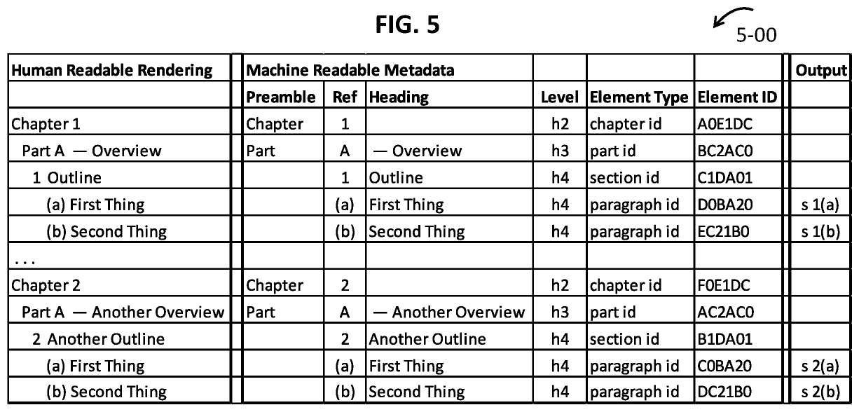

FIG. 5 is a chart 5-00 illustrating, in an embodiment of the invention, the relationship between: (a) a human readable rendering of a pinpoint element for a first local document 40A; (b) a set of machine readable metadata for the pinpoint element of the first local document 40A; and (c) a pinpoint element localized by the citation bridge platform 31 for a second local document 40B.

As illustrated in FIG. 5, the meta data of the pinpoint element includes a local preamble, a local reference (e.g., section number), a local heading, a local level, a local element type, and a local element ID. The local element ID, as used in this specification, is a machine readable alphanumeric identifier and is not typically displayed in the human readable rendering of the first local document 40A. Other metadata includes both the information needed for human readable rendering of the pinpoint element and also the relative hierarchy of the identified section within the first local document's 40A provisions. As illustrated, the human readable rendering of a pinpoint element description may be a phrase such as “Chapter 1”, “Part A—Overview”, “1 Outline”, or “(a) First Thing”. This information is included in the metadata of the pinpoint element.

As illustrated in the rightmost column of the chart 5-00 of FIG. 5, the output of the localization module 31E of the invention is a pinpoint element for the second local document 40B. Note that in this example, the pinpoint element of the second local document 40B combines meta data from more than one pinpoint element of the first local document 40A. E.g., “s1(a)” is created from the combined metadata of the pinpoint elements identified with local element IDs CIDA01 and the D0BA20 of the first local document 40A. In this approach, each bridge element includes a set of bridge IDs to capture meta data from more than one pinpoint element of the first local document 40A. E.g., the citation bridge platform 31 recognizes the hierarchical level of each pinpoint element of the first local document 40A and is able to combine metadata from more than one pinpoint element of the first local document 40A into a single citation such as “s1(a)”.

An example of pinpoint elements in the code of an XML document that are arranged in a hierarchy is as set forth below.

```
<chapter id=“A0E1DC”>
  <h2>Chapter<number>1</number></h2>
  <part id=“BC2AC0”>
    <h3>Part <number>A</number> - Overview</h3>
    <section id=“C1DA01”>
      <h4><number>1</number>Outline</h4>
      <paragraph id=“D0BA20”><number>(a)</number> First
      Thing</paragraph>
      <paragraphid=“EC21B0”><number>(b)</number> Second
      Thing</paragraph>
    </section>
  </part>
</chapter>
```

Note that the meta data in this example is aligned with the meta data in chart 5-00 of FIG. 5. In a general sense, the local documents can be viewed as a finite hierarchical tree structure consisting of nodes. Each node can have a parent, which is either null or another node. Each node has children, which is an ordered set of nodes. Each pinpoint element is a node within one of the local documents, which has attributes which may include a local element ID and a local element type.

The formatting of a pinpoint element in the second local document 40B depends on the selection of the second local convention LC2. Referring to a subsection within the AGLC4 local syntax rules of the first local convention LC1 of Australia uses the abbreviation “sub-s” as listed in chart 2C-00 of FIG. 2C, to obtain “sub-s (1)”. Referring to this same subsection within the local syntax rules of the second local convention LC2 of second country could use the abbreviation “ss” to preface the subsection reference, to obtain “ss (1)”. Hence, using the invention, legal professionals in the second country could view the citations in a citation format to which they are accustomed.

The invention can also be used for formatting of citations for the user interface displayed by a legal software tool. E.g., the “second local convention” could be the citation format employed by the software tool. In this manner, a single software tool could be employed to summarize the provisions of multiple jurisdictions.

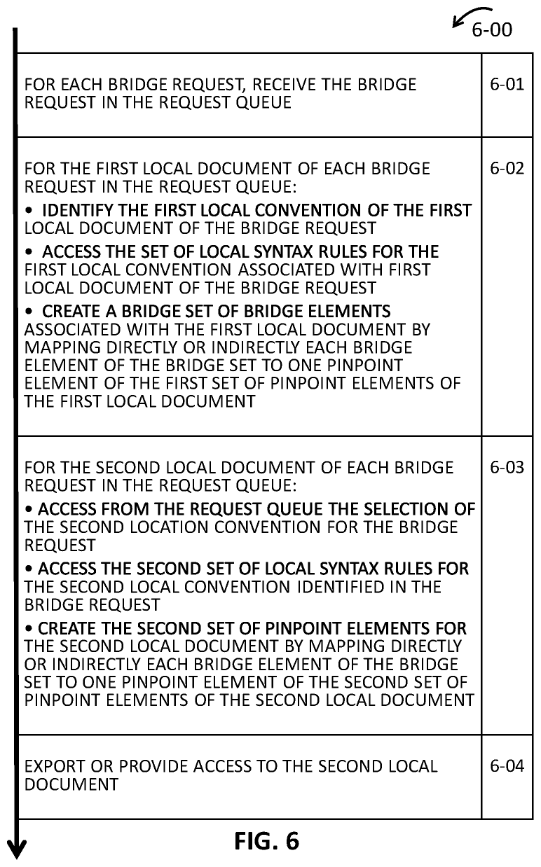

FIG. 6 is a flowchart detailing method steps in an embodiment of the invention. As detailed below, FIG. 6 includes four steps arranged from 6-01 to 6-04.
6-01 for each bridge request, receive the bridge request in the request queue 31C
6-02 for the first local document 40A of each bridge request in the request queue 31C:
   identify the first local convention LC1 of the first local document 40A of the bridge request
   access the set of local syntax rules for the first local convention LC1 associated with first local document 40A of the bridge request
   create a bridge set 40C of bridge elements associated with the first local document 40A by mapping directly or indirectly each bridge element of the bridge set 40C to one pinpoint element of the first set of pinpoint elements of the first local document 40A
6-03 for the second local document 40B of each bridge request in the request queue 31C:
   access from the request queue 31C the selection of the second location convention for the bridge request
   access the second set of local syntax rules for the second local convention LC2 identified in the bridge request
   create the second set of pinpoint elements for the second local document 40B by mapping directly or indirectly each bridge element of the bridge set 40C to one pinpoint element of the second set of pinpoint elements of the second local document 40B
6-04 export or provide access to the second local document 40B

A general embodiment of the invention is a citation bridge platform 31 or a computer-implemented method for receiving and localizing bridge requests. Each bridge request includes or links to a first local document 40A with a first set of pinpoint elements formatted according to a first local convention LC1. Each bridge request also identifies a second local convention LC2 to which the first set of pinpoint elements should be localized to create a second set of pinpoint element for a second local document 40B. The platform 31 or method 10 first globalizes the set of pinpoint elements of the first local document 40A by mapping them to a bridge set 40C of bridge elements formatted according to a bridge convention BC. Second, the platform 31 or method creates the second set of pinpoint elements for the second local document 40B by mapping the bridge set 40C of bridge elements into the second set of pinpoint elements created for the second local document 40B. The second set of pinpoint elements are formatted according to the second local convention LC2 of the second local document 40B.

A platform embodiment of the invention is a citation bridge platform 31 for receiving and localizing a plurality of bridge requests, the platform 31 including: (a) a bridge library 31B; (b) a request queue 31C; (c) a globalization module 31D; (d) a localization module 31E; and (e) an output module 31F configured to export or provide access to the second local document 40B.

The bridge library 31B of the platform embodiment is configured to store or link directly or indirectly to: (i) a plurality of local conventions for local documents; and (ii) a bridge convention BC. Each local convention includes a set of local syntax rules dictating formatting of pinpoint elements contained within the local documents associated with the local convention. Each pinpoint element includes a local element ID, a local element type, and a local reference. The bridge convention BC includes a set of bridge syntax rules dictating formatting of bridge elements. Each bridge element includes at least one bridge element ID, at least one bridge element type, and at least one bridge reference.

The request queue 31C of the platform embodiment is configured to receive each of the plurality of bridge requests. Each bridge request includes or links directly or indirectly to: (i) a first local document 40A of the local documents; and (ii) a selection of a second local convention LC2 of the local conventions for generation of a second local document 40B with a second set of pinpoint elements formatted according to a second set of local syntax rules according the second local convention LC2. The first local document 40A includes a first set of pinpoint elements. The first set of pinpoint elements are formatted according to a first set of local syntax rules according to a first local convention LC1 of the local conventions.

The globalization module 31D of the platform embodiment is in data communication with: (1) the bridge library 31B; and (2) the request queue 31C. For the first local document 40A of each bridge request, the globalization module 31D is configured to: (1) identify the first local convention LC1 of the first local document 40A of the bridge request; (2) access the set of local syntax rules for the first local convention LC1 associated with first local document 40A of the bridge request; and (3) create a bridge set 40C of bridge elements associated with the first local document 40A by mapping directly or indirectly each bridge element of the bridge set 40C to one pinpoint element of the first set of pinpoint elements of the first local document 40A. The at least one bridge element ID of the bridge element of the bridge set 40C is mapped directly or indirectly to the local element ID of the one pinpoint element of the first set of pinpoint elements of the first local document 40A. The at least one bridge element type of the bridge element of the bridge set 40C is mapped directly or indirectly to the local element type of the one pinpoint element of the first set of pinpoint elements of the first local document 40A. The at least one bridge reference of the bridge element of the bridge set 40C is mapped directly or indirectly to the local reference of the one pinpoint element of the first set of pinpoint elements of the first local document 40A.

The localization module 31E of the platform embodiment is, for each bridge request, linked directly or indirectly to: (1) the request queue 31C; (2) the bridge library 31B; and (3) the bridge set 40C of bridge elements associated with the first local document 40A of the bridge request. For the second local document 40B of each bridge request, the localization module 31E is configured to: (1) access from the request queue 31C the selection of the second location convention for the bridge request; (2) access the second set of local syntax rules for the second local convention LC2 identified in the bridge request; and (3) create the second set of pinpoint elements for the second local document 40B by mapping directly or indirectly each bridge element of the bridge set 40C to one pinpoint element of the second set of pinpoint elements of the second local document 40B. The at least one bridge element ID of the bridge element of the bridge set 40C is mapped directly or indirectly to the local element ID of the one pinpoint element of the second set of pinpoint elements of the second local document 40B. The at least one bridge element type of the bridge element of the bridge set 40C is mapped directly or indirectly to the local element type of the one pinpoint element of the second set of pinpoint elements of the second local document 40B. The at least one bridge reference of the bridge element of the bridge set 40C is mapped directly or indirectly to the local reference of the one pinpoint element of the second set of pinpoint elements of the second local document 40B.

A first alternative of the platform embodiment further comprises a web server 31A or an app server. The web server 31A is in data communication with a plurality of computing devices 32A through a network 32C, each computing device 32A including a user interface. The web server 31A or the app server supports, for each computing device, an entry portal for submitting at least one of the bridge requests through the user interface of the computing device. The entry portal includes an upload feature or a link feature for the first local document 40A of the bridge request. Optionally in the first alternative of the platform embodiment, for each bridge request submitted through one of the entry portals supported by the web server 31A or the app server: (a) the bridge library 31B can store or link directly or indirectly to a listing of local conventions; (b) the web server 31A can provide the listing of local conventions to the entry portal prompting a first user identification of the first local convention LC1 of the first local document 40A; and (c) the globalization module 31D can identify the first local convention LC1 of the first local document 40A of the bridge request from the first user identification. Optionally in the first alternative of the platform embodiment, for each bridge request submitted through one of the entry portals supported by the web server 31A or the app server: (a) the bridge library 31B can store or link directly or indirectly to a listing of local conventions; and (b) the web server 31A can provide the listing of local conventions on the entry portal prompting a second user identification of the second local convention LC2 of the second local document 40B.

In a second alternative of the platform embodiment, for each bridge request, the globalization module 31D identifies the first local convention LC1 of the first local document 40A from a first header 41A in the first local document 40A. Optionally in the second alternative of the platform embodiment, the first header 41A of the first local document 40A can link directly or indirectly to a first namespace 42A accessible via a network 32C to a first local server 32B hosting the local syntax rules of the first local convention LC1 of the first local document 40A.

In a third alternative of the platform embodiment, for each bridge request, the globalization module 31D can identify the first local convention LC1 of the first local document 40A from a comparator submodule configured to make a syntax comparison between: (a) one or more of the pinpoint elements of the set of first set of pinpoint elements in the first local document 40A; and (b) a sample set of local syntax rules from a sample set of local conventions stored or linked directly or indirectly by the bridge library 31B.

In a fourth alternative of the platform embodiment, for each bridge request, the localization module 31E embeds the second local convention LC2 of the second local document 40B within a second header 41B in the second local document 40B. Optionally in the fourth alternative of the platform embodiment, the second header 41B of the second local document 40B can link directly or indirectly to a second namespace 42B accessible via a network 32C to a second local server 32B hosting the local syntax rules of the second local convention LC2 of the second local document 40B.

In a fifth alternative of the platform embodiment: (a) each bridge element includes a set of bridge IDs; and (b) each bridge ID of the set of bridge IDs identifies one of a plurality of bridge levels associated with a local level of the pinpoint ID mapped to the set of bridge IDs.

A method embodiment of the invention is a computer-implemented method for receiving and localizing a plurality of bridge requests, the method comprising: (a) maintaining a bridge library 31B; (b) maintaining a request queue 31C; and (c) exporting or providing access to a second local document 40B.

In the method embodiment, the bridge library 31B is configured to store or link directly or indirectly to: (i) a plurality of local conventions for local documents; and (ii) a bridge convention BC. Each local convention includes a set of local syntax rules dictating formatting of pinpoint elements contained within the local documents associated with the local convention. Each pinpoint element includes a local element ID, a local element type, and a local reference. The bridge convention BC includes a set of bridge syntax rules dictating formatting of bridge element. Each bridge element includes at least one bridge element ID, at least one bridge element type, and at least one bridge reference;

In the method embodiment, the request queue 31C is configured to receive each of the plurality of bridge requests. Each bridge request includes or links directly or indirectly to: (i) a first local document 40A of the local documents; and (ii) a selection of a second local convention LC2 of the local conventions for generation of a second local document 40B with a second set of pinpoint elements formatted according to a second set of local syntax rules according the second local convention LC2. The first local document 40A includes a first set of pinpoint elements. The first set of pinpoint elements are formatted according to a first set of local syntax rules according to a first local convention LC1 of the local conventions.

In the method embodiment, for the first local document 40A of each bridge request in the request queue 31C, the method includes: (i) identifying the first local convention LC1 of the first local document 40A of the bridge request; (ii) accessing the set of local syntax rules for the first local convention LC1 associated with first local document 40A of the bridge request; and (iii) creating a bridge set 40C of bridge elements associated with the first local document 40A by mapping directly or indirectly each bridge element of the bridge set 40C to one pinpoint element of the first set of pinpoint elements of the first local document 40A.

In the method embodiment, for the second local document 40B of each bridge request in the request queue 31C, the method includes: (i) accessing from the request queue 31C the selection of the second location convention for the bridge request; (ii) accessing the second set of local syntax rules for the second local convention LC2 identified in the bridge request; and (iii) creating the second set of pinpoint elements for the second local document 40B by mapping directly or indirectly each bridge element of the bridge set 40C to one pinpoint element of the second set of pinpoint elements of the second local document 40B.

In the method embodiment, at least one bridge element ID of the bridge element of the bridge set 40C is mapped directly or indirectly to the local element ID of the one pinpoint element of the first set of pinpoint elements of the first local document 40A. The at least one bridge element type of the bridge element of the bridge set 40C is mapped directly or indirectly to the local element type of the one pinpoint element of the first set of pinpoint elements of the first local document 40A. The at least one bridge reference of the bridge element of the bridge set 40C is mapped directly or indirectly to the local reference of the one pinpoint element of the first set of pinpoint elements of the first local document 40A;

In the method embodiment, at least one bridge element ID of the bridge element of the bridge set 40C is mapped directly or indirectly to the local element ID of the one pinpoint element of the second set of pinpoint elements of the second local document 40B. The at least one bridge element type of the bridge element of the bridge set 40C is mapped directly or indirectly to the local element type of the one pinpoint element of the second set of pinpoint elements of the second local document 40B. The at least one bridge reference of the bridge element of the bridge set 40C is mapped directly or indirectly to the local reference of the one pinpoint element of the second set of pinpoint elements of the second local document 40B.

A first alternative of the method embodiment further comprises maintaining a web server 31A or an app server. The web server 31A is in data communication with a plurality of computing devices 32A through a network 32C, each computing device 32A including a user interface. The web server 31A or the app server supports, for each computing device, an entry portal for submitting at least one of the bridge requests through the user interface of the computing device. The entry portal includes an upload feature or a link feature for the first local document 40A of the bridge request. Optionally, in the first alternative of the method embodiment, for each bridge request submitted through one of the entry portals supported by the web server 31A or the app server: (a) the bridge library 31B can store or link directly or indirectly to a listing of local conventions; (b) the web server 31A can provide the listing of local conventions to the entry portal prompting a first user identification of the first local convention LC1 of the first local document 40A; and (c) the step of identifying the first local convention LC1 of the first local document 40A of the bridge request can include identifying the first local convention LC1 of the first local document 40A of the bridge request from the first user identification. Optionally, in the first alternative of the method embodiment, for each bridge request submitted through one of the entry portals supported by the web server 31A or the app server: (a) the bridge library 31B can store or link directly or indirectly to a listing of local conventions; and (b) the web server 31A can provide the listing of local conventions on the entry portal prompting a second user identification of the second local convention LC2 of the second local document 40B.

In a second alternative of the method embodiment, the step of identifying the first local convention LC1 of the first local document 40A for each bridge request includes identifying the first local convention LC1 of the first local document 40A from a first header 41A in the first local document 40A. Optionally in the second alternative of the method embodiment, the first header 41A of the first local document 40A can link directly or indirectly to a first namespace 42A accessible via a network 32C to a first local server 32B hosting the local syntax rules of the first local convention LC1 of the first local document 40A.

In a third alternative of the method embodiment, the step of identifying the first local convention LC1 for each bridge request includes identifying the first local convention LC1 of the first local document 40A from a syntax comparison between: (a) one or more of the pinpoint elements of the set of first set of pinpoint elements in the first local document 40A; and (b) a sample set of local syntax rules from a sample set of local conventions stored or linked directly or indirectly by the bridge library 31B.

A fourth alternative of the method embodiment further comprises, for each bridge request, embedding the second local convention LC2 of the second local document 40B within a second header 41B in the second local document 40B. Optionally in the fourth alternative of the method embodiment, the second header 41B of the second local document 40B can link directly or indirectly to a second namespace 42B accessible via a network 32C to a second local server 32B hosting the local syntax rules of the second local convention LC2 of the second local document 40B.

In a fifth alternative of the method embodiment: (a) each bridge element includes a set of bridge IDs; and (b) each bridge ID of the set of bridge IDs identifies one of a plurality of bridge levels associated with a local level of the pinpoint ID mapped to the set of bridge IDs.

While various aspects and embodiments have been disclosed herein, it will be apparent that various other modifications and adaptations of the invention will be apparent to the person skilled in the art after reading the foregoing disclosure without departing from the spirit and scope of the invention and it is intended that all such modifications and adaptations come within the scope of the appended claims. The various aspects and embodiments disclosed herein are for purposes of illustration and are not intended to be limiting, with the true scope and spirit of the invention being indicated by the appended claims.

1. A citation bridge platform for receiving and localizing a plurality of bridge requests, the platform including:
(a) a bridge library configured to store or link directly or indirectly to:
(i) a plurality of local conventions for local documents,
(1) wherein each local convention includes a set of local syntax rules dictating formatting of pinpoint elements contained within the local documents associated with the local convention; and
(2) wherein each pinpoint element includes a local element ID, a local element type, and a local reference; and
(ii) a bridge convention,
(1) wherein the bridge convention includes a set of bridge syntax rules dictating formatting of bridge elements; and
(2) wherein each bridge element includes at least one bridge element ID, at least one bridge element type, and at least one bridge reference;
(b) a request queue configured to receive each of the plurality of bridge requests, wherein each bridge request includes or links directly or indirectly to:
(i) a first local document of the local documents,
(1) wherein the first local document includes a first set of pinpoint elements; and
(2) wherein the first set of pinpoint elements are formatted according to a first set of local syntax rules according to a first local convention of the local conventions; and
(ii) a selection of a second local convention of the local conventions for generation of a second local document with a second set of pinpoint elements formatted according to a second set of local syntax rules according the second local convention;
(c) a globalization module,
(i) wherein the globalization module is in data communication with:
(1) the bridge library; and
(2) the request queue; and
(ii) wherein, for the first local document of each bridge request, the globalization module is configured to:
(1) identify the first local convention of the first local document of the bridge request;
(2) access the set of local syntax rules for the first local convention associated with first local document of the bridge request; and
(3) create a bridge set of bridge elements associated with the first local document by mapping directly or indirectly each bridge element of the bridge set to one pinpoint element of the first set of pinpoint elements of the first local document,
(a) wherein the at least one bridge element ID of the bridge element of the bridge set is mapped directly or indirectly to the local element ID of the one pinpoint element of the first set of pinpoint elements of the first local document;
(b) wherein the at least one bridge element type of the bridge element of the bridge set is mapped directly or indirectly to the local element type of the one pinpoint element of the first set of pinpoint elements of the first local document; and
(c) wherein the at least one bridge reference of the bridge element of the bridge set is mapped directly or indirectly to the local reference of the one pinpoint element of the first set of pinpoint elements of the first local document;
(d) a localization module,
(i) wherein, for each bridge request, the localization module is linked directly or indirectly to:
(1) the request queue;
(2) the bridge library; and
(3) the bridge set of bridge elements associated with the first local document of the bridge request; and
(ii) wherein, for the second local document of each bridge request, the localization module is configured to:
(1) access from the request queue the selection of the second location convention for the bridge request;
(2) access the second set of local syntax rules for the second local convention identified in the bridge request; and
(3) create a second set of pinpoint elements for the second local document by mapping directly or indirectly each bridge element of the bridge set to one pinpoint element of the second set of pinpoint elements of the second local document,
(a) wherein the at least one bridge element ID of the bridge element of the bridge set is mapped directly or indirectly to the local element ID of the one pinpoint element of the second set of pinpoint elements of the second local document;
(b) wherein the at least one bridge element type of the bridge element of the bridge set is mapped directly or indirectly to the local element type of the one pinpoint element of the second set of pinpoint elements of the second local document; and
(c) wherein the at least one bridge reference of the bridge element of the bridge set is mapped directly or indirectly to the local reference of the one pinpoint element of the second set of pinpoint elements of the second local document; and
(e) an output module configured to export or provide access to the second local document.

2. The platform of claim 1, further comprising a web server or an app server,
(a) wherein the web server is in data communication with a plurality of computing devices through a network, each computing device including a user interface;
(b) wherein the web server or the app server supports, for each computing device, an entry portal for submitting at least one of the bridge requests through the user interface of the computing device; and
(c) wherein the entry portal includes an upload feature or a link feature for the first local document of the bridge request.

3. The platform of claim 2, wherein, for each bridge request submitted through one of the entry portals supported by the web server or the app server:
(a) the bridge library stores or links directly or indirectly to a listing of local conventions;
(b) the web server provides the listing of local conventions to the entry portal prompting a first user identification of the first local convention of the first local document; and
(c) the globalization module identifies the first local convention of the first local document of the bridge request from the first user identification.

4. The platform of claim 2, wherein, for each bridge request submitted through one of the entry portals supported by the web server or the app server:
(a) the bridge library stores or links directly or indirectly to a listing of local conventions; and
(b) the web server provides the listing of local conventions on the entry portal prompting a second user identification of the second local convention of the second local document.

5. The platform of claim 1, wherein, for each bridge request, the globalization module identifies the first local convention of the first local document from a first header in the first local document.

6. The platform of claim 5, wherein the first header of the first local document links directly or indirectly to a first namespace accessible via a network to a first local server hosting the local syntax rules of the first local convention of the first local document.

7. The platform of claim 1, wherein, for each bridge request, the globalization module identifies the first local convention of the first local document from a comparator submodule configured to make a syntax comparison between:
(a) one or more of the pinpoint elements of the set of first set of pinpoint elements in the first local document; and
(b) a sample set of local syntax rules from a sample set of local conventions stored or linked directly or indirectly by the bridge library.

8. The platform of claim 1, wherein, for each bridge request, the localization module embeds the second local convention of the second local document within a second header in the second local document.

9. The platform of claim 8, wherein the second header of the second local document links directly or indirectly to a second namespace accessible via a network to a second local server hosting the local syntax rules of the second local convention of the second local document.

10. The platform of claim 1,
(a) wherein each bridge element includes a set of bridge IDs; and
(b) wherein each bridge ID of the set of bridge IDs identifies one of a plurality of bridge levels associated with a local level of the pinpoint ID mapped to the set of bridge IDs.

11. A computer-implemented method for receiving and localizing a plurality of bridge requests, the method comprising:
(a) maintaining a bridge library configured to store or link directly or indirectly to:
(i) a plurality of local conventions for local documents,
(1) wherein each local convention includes a set of local syntax rules dictating formatting of pinpoint elements contained within the local documents associated with the local convention; and
(2) wherein each pinpoint element includes a local element ID, a local element type, and a local reference; and
(ii) a bridge convention,
(1) wherein the bridge convention includes a set of bridge syntax rules dictating formatting of bridge elements; and
(2) wherein each bridge element includes at least one bridge element ID, at least one bridge element type, and at least one bridge reference;
(b) maintaining a request queue configured to receive each of the plurality of bridge requests, wherein each bridge request includes or links directly or indirectly to:
(i) a first local document of the local documents,
(1) wherein the first local document includes a first set of pinpoint elements; and
(2) wherein the first set of pinpoint elements are formatted according to a first set of local syntax rules according to a first local convention of the local conventions; and
(ii) a selection of a second local convention of the local conventions for generation of a second local document with a second set of pinpoint elements formatted according to a second set of local syntax rules according the second local convention;
(c) for each bridge request, receiving the bridge request in the request queue;
(d) for the first local document of each bridge request in the request queue:
(i) identifying the first local convention of the first local document of the bridge request;
(ii) accessing the set of local syntax rules for the first local convention associated with first local document of the bridge request; and
(iii) creating a bridge set of bridge elements associated with the first local document by mapping directly or indirectly each bridge element of the bridge set to one pinpoint element of the first set of pinpoint elements of the first local document,
(1) wherein the at least one bridge element ID of the bridge element of the bridge set is mapped directly or indirectly to the local element ID of the one pinpoint element of the first set of pinpoint elements of the first local document;
(2) wherein the at least one bridge element type of the bridge element of the bridge set is mapped directly or indirectly to the local element type of the one pinpoint element of the first set of pinpoint elements of the first local document; and
(3) wherein the at least one bridge reference of the bridge element of the bridge set is mapped directly or indirectly to the local reference of the one pinpoint element of the first set of pinpoint elements of the first local document;
(e) for the second local document of each bridge request in the request queue:
(i) accessing from the request queue the selection of the second location convention for the bridge request;
(ii) accessing the second set of local syntax rules for the second local convention identified in the bridge request; and
(iii) creating the second set of pinpoint elements for the second local document by mapping directly or indirectly each bridge element of the bridge set to one pinpoint element of the second set of pinpoint elements of the second local document,
(1) wherein the at least one bridge element ID of the bridge element of the bridge set is mapped directly or indirectly to the local element ID of the one pinpoint element of the second set of pinpoint elements of the second local document;
(2) wherein the at least one bridge element type of the bridge element of the bridge set is mapped directly or indirectly to the local element type of the one pinpoint element of the second set of pinpoint elements of the second local document; and
(3) wherein the at least one bridge reference of the bridge element of the bridge set is mapped directly or indirectly to the local reference of the one pinpoint element of the second set of pinpoint elements of the second local document; and
(f) exporting or providing access to the second local document.

12. The method of claim 11, further comprising maintaining a web server or an app server,
(a) wherein the web server is in data communication with a plurality of computing devices through a network, each computing device including a user interface;
(b) wherein the web server or the app server supports, for each computing device, an entry portal for submitting at least one of the bridge requests through the user interface of the computing device; and
(c) wherein the entry portal includes an upload feature or a link feature for the first local document of the bridge request.

13. The method of claim 12, wherein, for each bridge request submitted through one of the entry portals supported by the web server or the app server:
(a) the bridge library stores or links directly or indirectly to a listing of local conventions;
(b) the web server provides the listing of local conventions to the entry portal prompting a first user identification of the first local convention of the first local document; and
(c) the step of identifying the first local convention of the first local document of the bridge request includes identifying the first local convention of the first local document of the bridge request from the first user identification.

14. The method of claim 12, wherein, for each bridge request submitted through one of the entry portals supported by the web server or the app server:
(a) the bridge library stores or links directly or indirectly to a listing of local conventions; and
(b) the web server provides the listing of local conventions on the entry portal prompting a second user identification of the second local convention of the second local document.

15. The method of claim 11, wherein the step of identifying the first local convention of the first local document for each bridge request includes identifying the first local convention of the first local document from a first header in the first local document.

16. The method of claim 15, wherein the first header of the first local document links directly or indirectly to a first namespace accessible via a network to a first local server hosting the local syntax rules of the first local convention of the first local document.

17. The method of claim 11, wherein the step of identifying the first local convention for each bridge request includes identifying the first local convention of the first local document from a syntax comparison between:
(a) one or more of the pinpoint elements of the set of first set of pinpoint elements in the first local document; and
(b) a sample set of local syntax rules from a sample set of local conventions stored or linked directly or indirectly by the bridge library.

18. The method of claim 11, further comprising, for each bridge request, embedding the second local convention of the second local document within a second header in the second local document.

19. The method of claim 18, wherein the second header of the second local document links directly or indirectly to a second namespace accessible via a network to a second local server hosting the local syntax rules of the second local convention of the second local document.

20. The method of claim 11,
(a) wherein each bridge element includes a set of bridge IDs; and
(b) wherein each bridge ID of the set of bridge IDs identifies one of a plurality of bridge levels associated with a local level of the pinpoint ID mapped to the set of bridge IDs.
